(19) United States
(12) Patent Application Publication
(10) Pub. No.: US 2016/0125765 A1
(43) Pub. Date: May 5, 2016

(54) SYSTEMS AND METHODS FOR INTERACTIVE PRODUCT TRAINING

(71) Applicants: Attila MERETEI, Hanover, NH (US); Simon KIRSCH, London (GB)

(72) Inventors: Attila MERETEI, Hanover, NH (US); Simon KIRSCH, London (GB)

(21) Appl. No.: 14/889,264

(22) PCT Filed: May 5, 2014
(86) PCT No.: PCT/US2014/036829

§ 371 Date: Nov. 5, 2015

Related U.S. Application Data
(60) Provisional application No. 61/819,974, filed on May 6, 2013.

(51) Int. Cl. G09B 23/28; G09B 5/02

(52) U.S. Cl. CPC G09B 23/28; G09B 5/02

(57) ABSTRACT

Provided are systems and methods for training an individual on product usage. The systems include a touch screen interface, a processor, a physical computer readable medium, and program instructions stored on the physical computer readable medium. The program instructions are executable by the processor to receive identification code information associated with a product, acquire a representation of the product from a physical computer readable medium, display the representation of the product on the touch screen interface, and respond to a user interacting with the representation. Methods of the present disclosure include reading a unique identification code associated with a product using an identification code reader of a computer, acquiring a representation of the product from a physical computer readable medium, displaying the representation of the product on a touch screen interface, and allowing an individual to interact with the representation of the product to train the individual on product usage.

### BACKGROUND

Although medical devices are an integral and indispensable component of patient care, they present a number of unique problems that have not been fully addressed by device manufacturers or the medical community in general. Errors in the understanding and use of medical devices are responsible for considerable morbidity and mortality. Government agencies have recently begun to look more closely at the ability of medical institutions as well as manufacturers to accurately assess the dangers presented by medical devices. Moreover, the FDA has mandated the use of “human factors” experts in the design of medical devices to reduce the complexity of the interface between device and human.

Medical device training is typically provided using textbooks, manuals, lectures, and videotapes. While providing a low-cost source for learning theory, such resources lack the benefits acquired from “hands-on” training and practice with the actual device. Patient simulator mannequins are presently available to provide hands-on training to medical personnel in areas such as trauma treatment and anesthesiology. Such mannequins may have significant capabilities including spontaneous breathing, a pulse, heart and breath sounds and the ability to monitor vital signs such as ECG, pulse oximetry and end-tidal carbon dioxide by connecting commercial off-the-shelf (COTS) medical devices to the simulator. Medical devices can be attached to these mannequins to train users in the proper implementation and use, e.g., endotracheal tube, EKG monitor, blood pressure cuff, pulse oximeter, automatic external defibrillator. These mannequins are typically computer controlled and are programmed for a variety of responses which simulate medical conditions.

### SUMMARY

Provided are systems, physical computer readable media, and methods for training an individual on product usage. Systems of the present disclosure include a touch screen interface, a processor, a physical computer readable medium, and program instructions stored on the physical computer readable medium. The program instructions are executable by the processor to receive unique identification code information associated with a product (e.g., a medical device), acquire a representation of the product from a physical computer readable medium where the representation of the product is stored, display the representation of the product on the touch screen interface, and respond to a user interacting with the representation via the touch screen interface. Methods of the present disclosure include reading a unique identification code associated with a product (e.g., a medical device) using an identification code reader of a computer, acquiring a representation of the product from a physical computer readable medium where the representation of the product is stored, displaying the representation of the product on a touch screen interface of the computer, and allowing an individual to interact with the representation of the product using the touch screen interface to train the individual on product usage.

### BRIEF DESCRIPTION OF THE DRAWINGS

The invention may be best understood from the following detailed description when read in conjunction with the accompanying drawings. Included in the drawings are the following figures:

FIG. 1 schematically illustrates a system according to one embodiment of the present disclosure.

FIG. 2 is a schematic illustration of a representation of a product on a touch screen interface according to one embodiment of the present disclosure.

FIG. 3 schematically illustrates a product image associated with a real object in the field of view of a camera of a system according to one embodiment of the present disclosure.

FIG. 4 is a flow diagram showing the steps of a method for training an individual on product usage according to one embodiment of the present disclosure.

### DETAILED DESCRIPTION

Provided are systems, physical computer readable media, and methods for training an individual on product usage. Systems of the present disclosure include a touch screen interface, a processor, a physical computer readable medium, and program instructions stored on the physical computer readable medium. The program instructions are executable by the processor to receive unique identification code information associated with a product (e.g., a medical device), acquire a representation of the product from a physical computer readable medium where the representation of the product is stored, display the representation of the product on the touch screen interface, and respond to a user interacting with the representation via the touch screen interface. Methods of the present disclosure include reading a unique identification code associated with a product (e.g., a medical device) using an identification code reader of a computer, acquiring a representation of the product from a physical computer readable medium where the representation of the product is stored, displaying the representation of the product on a touch screen interface of the computer, and allowing an individual to interact with the representation of the product using the touch screen interface to train the individual on product usage.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials may now be described. Any and all publications mentioned herein are incorporated herein by reference to disclose and describe the methods and/or materials in connection with which the publications are cited. It is understood that the present disclosure supersedes any disclosure of an incorporated publication to the extent there is a contradiction.

It must be noted that as used herein and in the appended claims, the singular forms “a”, “an”, and “the” include plural referents unless the context clearly dictates otherwise. Thus, for example, reference to “an electrode” includes a plurality of such electrodes and reference to “the signal” includes reference to one or more signals, and so forth.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publications may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Methods

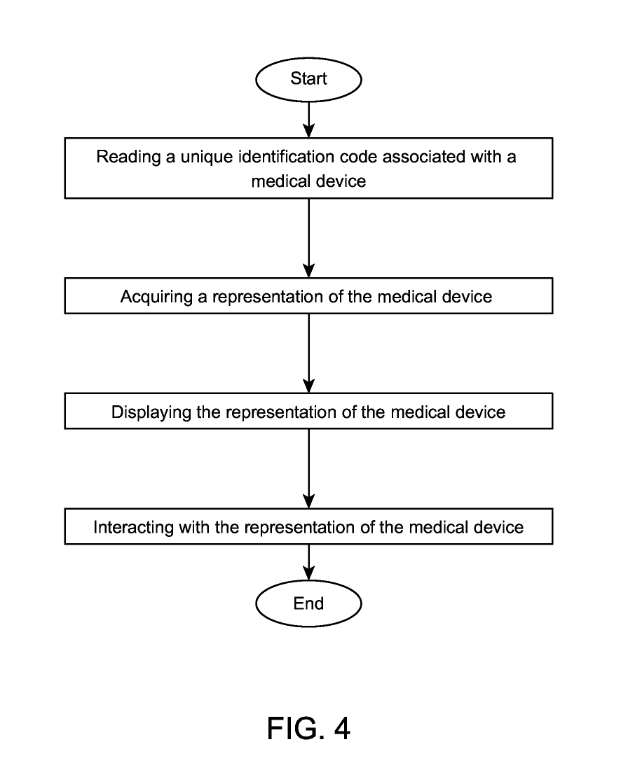

Provided by the present disclosure are methods for training an individual on product usage. The methods include reading a unique identification code associated with a product (e.g., a medical device) using an identification code reader of a computer, acquiring a representation of the product from a physical computer readable medium where the representation of the product is stored, displaying the representation of the product on a touch screen interface of the computer, and allowing an individual to interact with the representation of the product using the touch screen interface to train the individual on product usage. A flow diagram of an example method of the present disclosure is provided in FIG. 4. Aspects of steps of the methods will now be described in more detail.

Methods of the present disclosure may be practiced for training an individual on usage of any product of interest. In certain aspects, the methods are for training an individual on usage of a medical device. According to certain embodiments, the product is a medical device selected from an implant, an implant delivery system, a minimally invasive interventional device, a surgical instrument, a diagnostic device, a monitoring device, a life support device, an electrophysiology device, a robotic device, a prosthetic device, an imaging device, equipment thereof, and combinations thereof. Medical devices of interest include, but are not limited to, a catheter, a stent, a defibrillator, a pacemaker, a prosthesis, orthopedic hardware, a tympanostomy tube, an intraocular lens, a dialysis machine, a laryngoscope, a bronchoscope, an electrocardiography (ECG) machine, a blood pressure monitor, and a blood glucose monitor.

According to certain embodiments, the medical device is an endovascular medical device. Endovascular medical devices of interest include, but are not limited to, intracoronary medical devices including at least one of stents, drug delivery catheters, grafts, and drug delivery balloons utilized in a subject's vasculature. When the medical device is a stent, the stent includes peripheral stents, coronary stents, degradable coronary stents, non-degradable coronary stents, self-expanding stents, balloon-expanded stents, and esophageal stents. In other embodiments, the medical device includes at least one of, but is not limited to, arterio-venous grafts, by-pass grafts, penile implants, vascular implants and grafts, intravenous catheters, small diameter grafts, artificial lung catheters, electrophysiology catheters, bone pins, suture anchors, blood pressure and stent graft catheters, breast implants, benign prostatic hyperplasia and prostate cancer implants, bone repair/augmentation devices, breast implants, orthopedic joint implants, dental implants, implanted drug infusion tubes, oncological implants, pain management implants, neurological catheters, central venous access catheters, catheter cuff, vascular access catheters, urological catheters/implants, atherectomy catheters, clot extraction catheters, PTA catheters, PTCA catheters, stylets (vascular and non-vascular), drug infusion catheters, angiographic catheters, hemodialysis catheters, neurovascular balloon catheters, thoracic cavity suction drainage catheters, electrophysiology catheters, stroke therapy catheters, abscess drainage catheters, biliary drainage products, dialysis catheters, central venous access catheters, and parental feeding catheters.

In certain aspects, the product is a medical device that includes at least one of, but is not limited to, pacemakers, vascular grafts, sphincter devices, urethral devices, bladder devices, renal devices, gastroenteral and anastomotic devices, vertebral disks, hemostatic barriers, clamps, surgical staples/sutures/screws/plates/wires/clips, glucose sensors, blood oxygenator tubing, blood oxygenator membranes, blood bags, birth control/IUDs and associated pregnancy control devices, cartilage repair devices, orthopedic fracture repairs, tissue adhesives, tissue sealants, tissue scaffolds, CSF shunts, dental fracture repair devices, intravitreal drug delivery devices, nerve regeneration conduits, electrostimulation leads, spinal/orthopedic repair devices/hardware, wound dressings, embolic protection filters, abdominal aortic aneurysm grafts and devices, neuroaneurysm treatment coils, hemodialysis devices, uterine bleeding patches, anastomotic closures, in vitro diagnostics, aneurysm exclusion devices, neuropatches, vena cava filters, urinary dilators, endoscopic surgical and wound drainings, surgical tissue extractors, transition sheaths and dilators, coronary and peripheral guidewires, circulatory support systems, tympanostomy vent tubes, cerebrospinal fluid shunts, defibrillator leads, percutaneous closure devices, drainage tubes, bronchial tubes, vascular coils, vascular protection devices, vascular intervention devices including vascular filters and distal support devices and emboli filter/entrapment aids, AV access grafts, surgical tampons, drug delivery capsule and cardiac valves.

As set forth above, the subject methods include reading a unique identification code associated with a product (e.g., a medical device) using an identification code reader of a computer. Any code capable of uniquely identifying a product may be employed. In certain aspects, the reading includes reading a unique identification code selected from a two-dimensional (2D) code (e.g., a multiple-barcode layout, a 2D stacked barcode, a 2D matrix code, and the like), a bar code, a radio frequency identification (RFID) tag, a near-field communication (NFC) tag, a numeric code, individually-generated unique images, custom graphics, and combinations thereof. According to one embodiment, the unique identification code is a 2D matrix code. 2D matrix codes of interest include, but are not limited to, Quick Response (QR) codes, DataMatrix codes, Aztec codes, MaxiCode, Semacode tags, Cauzin Softstrip codes, EZcode, High Capacity Color Barcode (HCCB), CyberCode, Mobile Multi-Coloured Composite (MMCC), Dot codes, PDF417 symbols, ShotCode, SPARQCode, WaterCode, and Trusted Paper Key (TPK).

The unique identification code is disposed at a location that permits its association with the product for which usage training is desired. According to certain embodiments, the code is disposed on the product itself. In other aspects, the code is disposed on packaging of the product (e.g., a bag and/or box in which the product is packaged, a product insert that accompanies the product, and/or the like). In still other aspects, the unique identification code is disposed on the product and the product packaging. The unique identification code may include any encoded information useful for uniquely identifying the product, such as the identity of the product manufacturer/brand, model number, product code number, serial number, lot number, manufacturing date, and/or the like.

Reading the unique identification code is carried out using an identification code reader of a computer. In certain aspects, the identification code reader is a hand-held reader which is not integrated into the computer, but rather is attached to the computer via a wired or wireless connection (e.g., a hand-held reader wirelessly connected to, for example, a desktop computer). In other aspects, the identification code reader is integrated into the computer. For example, when the computer is a smartphone, tablet computer, or laptop computer, the identification code reader may be a camera present in the computer (e.g., a camera pre-installed and integrated into an iOS-, Android- or Windows-based smartphone or tablet computer). Software applications which enable camera-based reading of identification codes (e.g., QR Codes, barcodes, and the like) are commercially available for installation on such computers.

Reading the identification code permits the unique identification of the product. Once the product is uniquely identified, a representation of the product (e.g., a medical device) is acquired from a physical computer readable medium where the representation of the product is stored. Physical computer readable media that find use in the subject methods and systems include, but are not limited to, disks (e.g., magnetic or optical), solid-state storage drives, cards, tapes, drums, punched cards, barcodes, and magnetic ink characters and other physical medium that may be used for storing representations, instructions, and/or the like. The physical computer readable medium where the representation is stored may be present (or “integrated”) in the computer. For example, the representation may be one or more 2D or 3D images of the product stored on a drive (e.g., a disk drive or solid-state drive) present in the computer. In other aspects, the physical computer readable medium where the representation is stored is present in a remote server. For example, when the product is a medical device or other healthcare-related product, the remote server may in some instances be present in a hospital or clinic where a trainee for usage of the medical device is located, where the representation may be acquired via a wired (e.g., local area network) or wireless (e.g., WiFi) connection between the server and the computer. According to certain embodiments, the remote server is a server that is “off-site” with respect to the training site.

When the physical computer readable medium where the representation is stored is present in a remote server, the representation may be acquired by downloading and/or streaming the representation from the server to the computer via a communication network. The communication network may be, e.g., the internet, a local area network, a wireless network, a wired network, a mobile phone network, and/or any suitable communication network configured to enable acquisition of the representation by the computer from the server (e.g., via a communication module of the server).

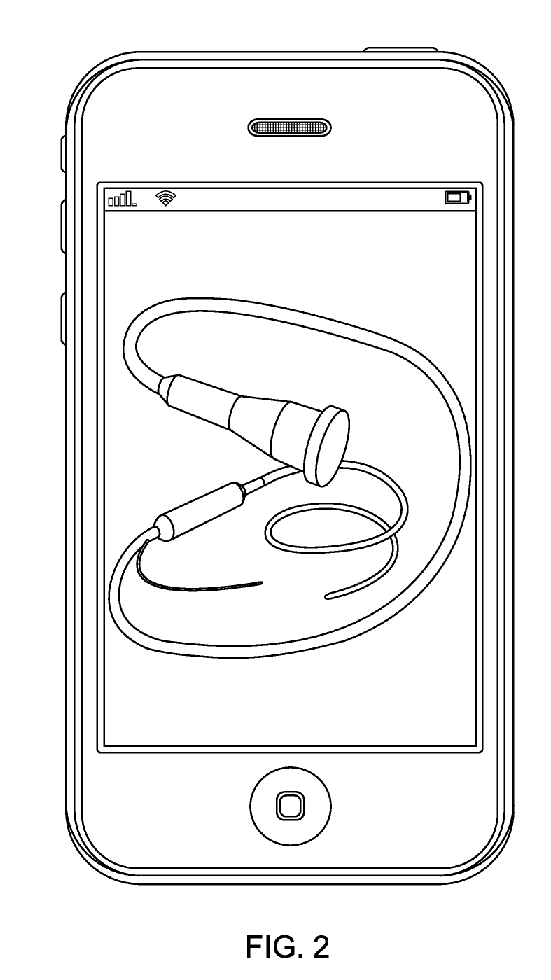

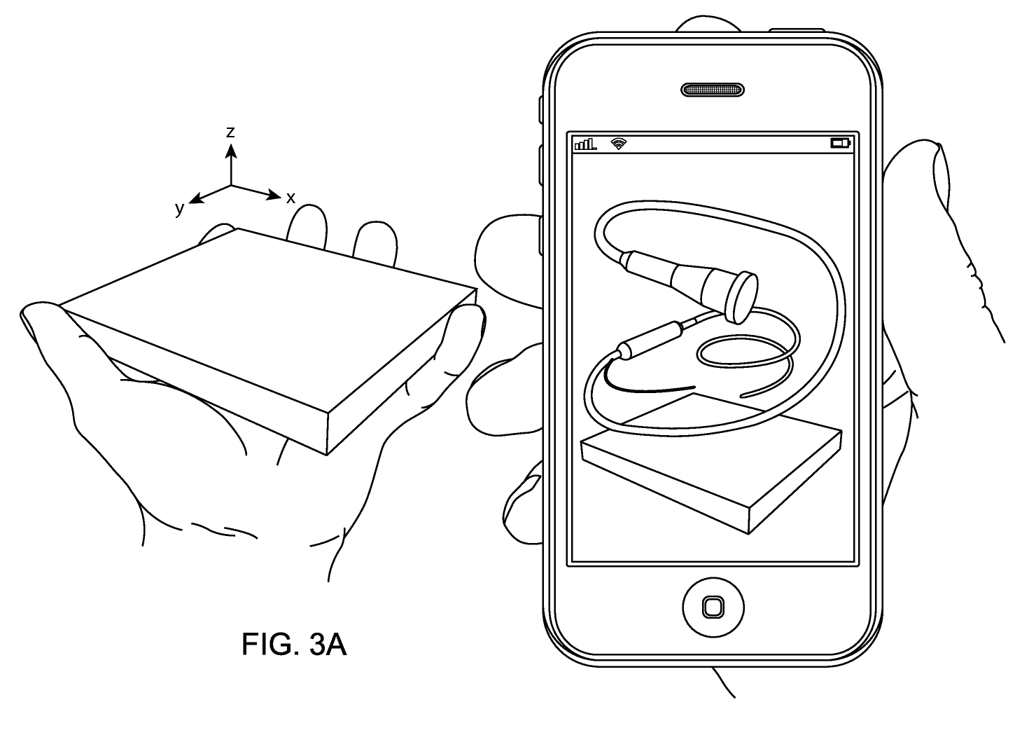

Aspects of the methods of the present disclosure include displaying the representation of the product (e.g., a medical device) on a touch screen interface of the computer. According to certain embodiments, displaying the representation of the product includes displaying an image of the product. Images of interest include, but are not limited to, a photo, a drawing, an animation, and/or a video. When the representation is an image of the product, the image displayed may be a two-dimensional (2D) or three-dimensional (3D) image of the product. In certain aspects, the 2D or 3D image is displayed such that the individual may view the image from multiple selectable angles and/or orientations to familiarize the individual with the product and facilitate usage training. A representation of a product being displayed on a touch screen interface according to one embodiment of the present disclosure is schematically illustrated in FIG. 2. As shown, in this example, an image of a medical device (here, a catheter) is displayed on the touch screen interface of a computer (in this example, a smartphone).

Once the representation is displayed, the subject methods include allowing an individual to interact with the representation of the product using the touch screen interface to train the individual on product usage (e.g., medical device usage). Approaches for allowing the individual to interact with the representation may vary. According to certain embodiments, the representation is an image of the product, and the interaction includes the individual touching the image of the product via the touch screen interface. Touching the image (e.g., tapping all or a portion of the image, or swiping up, down, left and/or right on the image) may result in a change of view of the image (e.g., rotation of the image in virtual 3D space), allowing the individual to become familiar with the product's appearance, shape, etc. prior to actually handling the product. In certain aspects, the interaction includes the individual touching a portion of the image to display information relating to the corresponding portion of the product.

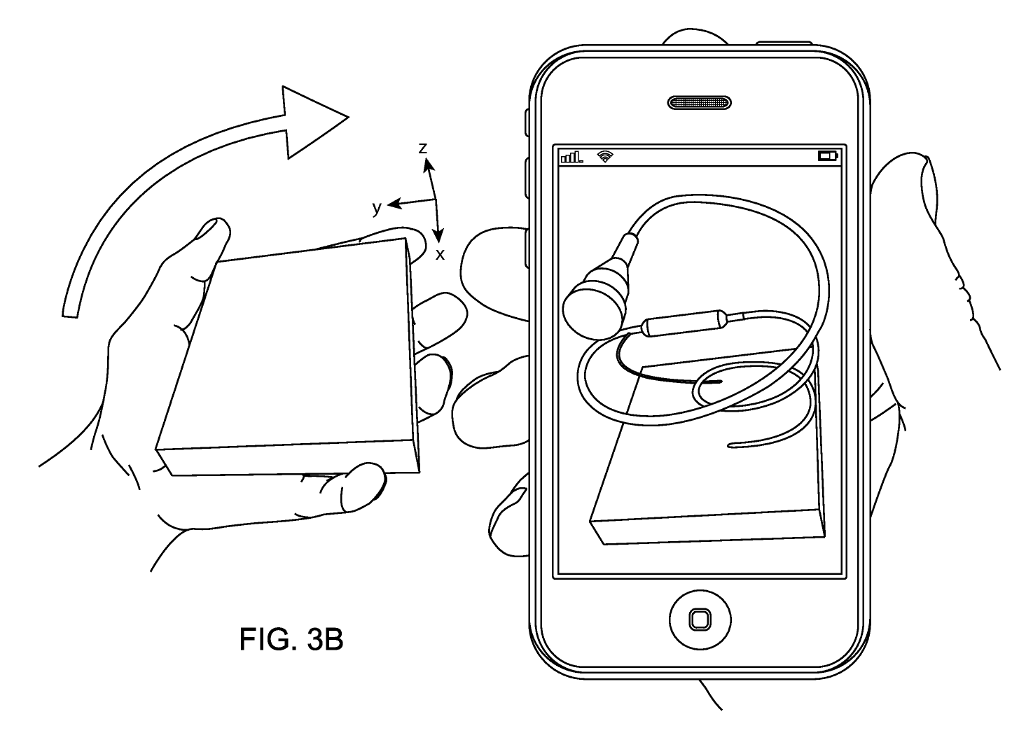

In certain aspects, the representation is an image of the product, where the image is associated with a real object in the field of view of a camera of the computer. For example, the individual may hold a camera-equipped smartphone or tablet computer such that a real object (e.g., a flat object, such as a substantially square or circular piece of material(s)) disposed in the field of view of the camera is visible on the touch screen interface. An image of the product is associated with the real object. For example, displaying the product image may be carried out using software that moves the product image in response to the real object being moved. In this way, the individual may interact with the product image, e.g., by moving the real object closer to or farther away from the camera to zoom in or zoom out on the product image, respectively. A schematic illustration of this embodiment of the present disclosure is provided in FIG. 3. In this example, the product is a medical device, specifically a catheter. As shown in FIG. 3A, an individual holds a real object within the field of view of a camera (not shown) of a computer (in this example, a smartphone). An image of the catheter is displayed on the touch screen above the real object and associated therewith. Moving the real object in the field of view of the camera results in the image of the catheter undergoing the corresponding movement. For example, as shown in FIG. 3B (and in comparison to FIG. 3A), rotating the real object horizontally to the right results in a corresponding rotation of the catheter image on the touchscreen interface, permitting the individual to “virtually” view the catheter from any desired angle as determined by the position and/or orientation of the real object.

According to certain embodiments, the subject methods include presenting to the individual information relating to the product, e.g., via a graphical user touch screen interface. For example, when the product is a medical device, methods of the present disclosure may include presenting to the individual information relating to the medical device, including but not limited to, technical information (e.g., information relating to properties (e.g., construction material, performance features, test data, etc.) of the medical device or components/regions thereof and/or alternative medical devices (e.g., marketed a competitor)); ordering information (e.g., enabling the individual to place an order for the medical device), instructions for using the medical device, indications for which the medical device finds use, information relating to FDA approval and/or FDA warnings regarding the medical device (e.g., presenting to the individual the indications for which the medical device is FDA-approved, presenting one or more warnings to the individual consistent with any FDA warnings that the medical device should not be used in a certain way or on individuals having a certain medical condition, and/or the like), or any combination thereof.

The computer employed in practicing the subject methods may vary. In certain aspects, the computer is selected from a smartphone, a tablet computer, a laptop computer, and a desktop computer. Smartphones or personal digital assistant devices of interest include, but are not limited to, the Apple iPhone, Android operating system-based smartphones commercially available from any number of manufacturers (e.g., Samsung, HTC, Huawei, Alcatel, Acer, Sony Ericsson, HTC, LG, Google Nexus, ZTE, Motorola, etc.), Windows-based smartphones, and the like. Tablet computers of interest include, but are not limited to, the Apple iPad, Android operating system-based tablets commercially available from any number of manufacturers (e.g., Acer, Archos, Dell, Motorola, Samsung, Sony, Toshiba, ZTE, etc.), Windows-based tablet computers, and the like.

According to any of the embodiments described above, the methods of the present disclosure may be methods of training an individual on usage of a medical device. In certain aspects, the methods employ an augmented reality technology that includes the following components: a unique code or trigger placed on the packaging of a medical device and/or the medical device itself, allowing the identification of the particular medical device by brand, product code number, and/or the like; and a software package installed on a mobile computing device, such as a tablet computer, smartphone, or laptop computer, that has a touch-sensitive screen and a camera. The software package may include one or more modules including, but not limited to: a module to recognize the code or trigger attached to the medical device packaging; a training module with multiple functions that provide interactive information on the medical device; a reporting module that tracks the use of the training module, and analyzes usage to identify possible improvement opportunities in the training module's content, organization and overall functionality; and/or an ordering module that allows the trainee to place and order for the same or another product.

The code or trigger can be a barcode, a numerical code, a QR code or any other code (e.g., such as those described elsewhere herein) that a camera-equipped computing device can use to identify the medical device. The training module on the computing device may include the following functions: displaying an image of the medical device on a screen (e.g., a touch screen). The image can be a photo, video, drawing, animation, etc. The image can be two- or three-dimensional, and may be displayed in virtual three dimensional space, where the individual can view it from different angles and from different virtual distances. The individual (or “user”) can interact with the device. For example, the individual can touch a portion of the device on screen to display information related to performance features, including engineering test data, data comparing the device to alternative devices, and/or the like. Other example forms of interaction include interacting with certain areas, regions or locations on the device, to display the function of that area, region, or location as a video or animation. For example, by touching the graphical representation of a button on a medical device, the function of that button can be demonstrated on screen (e.g., in the form of a change in the devices status). This interactive feature may be implemented to allow step-by-step rehearsal of device preparation or device use. It will be understood that the above-described augmented reality technology may be used to train an individual on usage of any product, and is not limited to medical devices in particular.

### Systems

As summarized above, aspects of the invention include systems. Systems of the present disclosure include a touch screen interface, a processor, a physical computer readable medium, and program instructions stored on the physical computer readable medium. The program instructions are executable by the processor to receive unique identification code information associated with a product (e.g., a medical device), acquire a representation of the product from a physical computer readable medium where the representation of the product is stored, display the representation of the product on the touch screen interface, and respond to a user interacting with the representation via the touch screen interface. Systems of the present disclosure find use, e.g., in practicing the subject methods of training an individual on usage of a product.

In certain aspects, the product is a medical device. The medical device may be any medical device described hereinabove with respect to the subject methods. According to certain embodiments, the product is a medical device selected from an implant, an implant delivery system, a minimally invasive interventional device, a surgical instrument, a diagnostic device, a monitoring device, a life support device, an electrophysiology device, a robotic device, a prosthetic device, an imaging device, equipment thereof, and combinations thereof. Medical devices of interest include, but are not limited to, a catheter, a stent, a defibrillator, a pacemaker, a prosthesis, orthopedic hardware, a tympanostomy tube, an intraocular lens, a dialysis machine, a laryngoscope, a bronchoscope, an electrocardiography (ECG) machine, a blood pressure monitor, and a blood glucose monitor.

The unique identification code information may be received from any suitable code. In certain aspects, the unique identification code information is received from a code selected from a 2D matrix code, a bar code, a radio frequency identification (RFID) tag, a near-field communication (NFC) tag, a numeric code, individually-generated unique images, custom graphics, and combinations thereof. According to one embodiment, the unique identification code is a 2D matrix code (e.g., a QR Code®).

The unique identification code information may be received from a code present at a location that permits its association with the product. In certain aspects, the code is disposed on the product itself, packaging of the product, or both the product and product packaging. According to certain embodiments, systems of the present disclosure include the unique identification code.

The system may be any suitable system having a touch screen interface, a processor, and a physical computer readable medium having instructions stored thereon. In certain aspects, the system is a smartphone, tablet computer, laptop computer, or desktop computer. Smartphones and tablet computers of interest are described above with respect to the subject methods and include, but are not limited to, iOS-based smartphones or tablet computers (e.g., an iPhone or iPad, respectively), Android- or Windows-based smartphones or tablet computers, and the like.

The physical computer readable medium where the representation of the product is stored may be the same physical computer readable medium where the program instructions are stored. In other aspects, the physical computer readable medium where the representation of the product is stored is present in a remote server. According to certain aspects, the representation of the product is an image of the product. The image can be a photo, video, drawing, animation, etc. The image can be two- or three-dimensional, and may be displayed in virtual three dimensional space, where the individual can view it from different angles and from different virtual distances. Systems of the invention may include program instructions to display information relating to a portion of the product in response to a user touching a corresponding portion of the image via the touch screen interface. Alternatively, or additionally, the system may include program instructions to move the image (e.g., in response to a user touching the image via the touch screen interface) in two- or three-dimensional space.

According to certain embodiments, when the representation of the product is an image, the image of the product may be associated with a real object in the field of view of a camera of the system. For example, displaying the product image may be carried out using camera software that moves the product image in response to the real object being moved. In this way, the individual may interact with the product image, e.g., by moving the real object closer to or farther away from the camera to zoom in or zoom out on the product image, respectively.

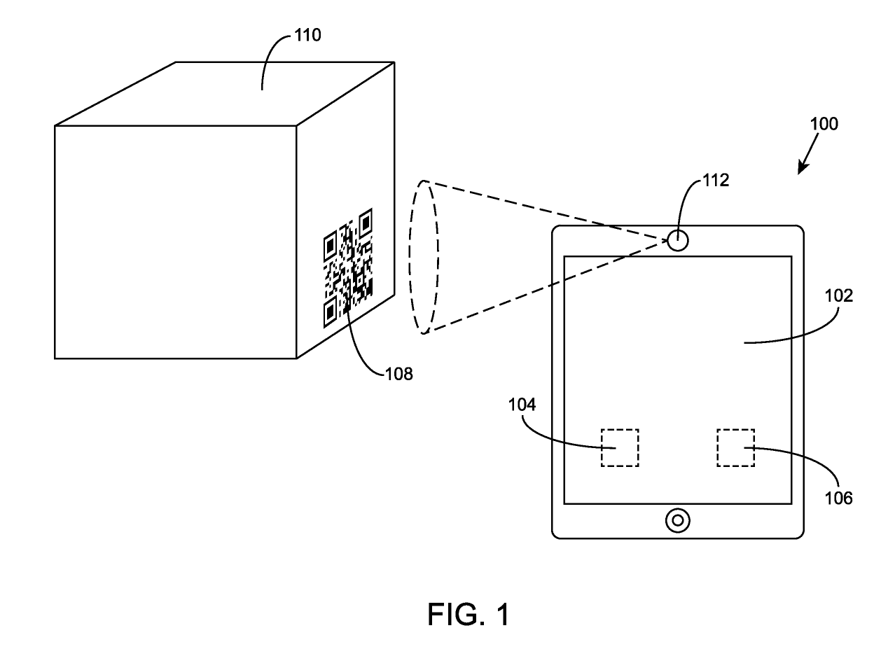

A system according to one embodiment of the present disclosure is schematically illustrated in FIG. 1. As shown, a system (in this example, tablet computer 100) includes touch screen interface 102, processor 104, and physical computer readable medium 106. Processor 104 and physical computer readable medium 106 are located internally within the system, as indicated using dashed lines. The system receives product identification information from unique identification code 108 present on product packaging 110 using an identification code reader (in this example, camera 112) of the system. Once the product is identified, a representation of the product may be acquired and displayed on the touch screen interface for interaction with an individual for product usage training.

Systems of the present disclosure may include any of the components, or include program instructions to carry out any of the steps or provide any of the functionalities or information, as described above with respect to the subject methods. In certain aspects, systems of the invention include program instructions for presenting to the individual information relating to the product, e.g., via a graphical user touch screen interface. For example, when the product is a medical device, systems of the present disclosure may include instructions for presenting to an individual information relating to the medical device, including but not limited to, technical information (e.g., information relating to properties (e.g., construction material, performance features, test data, etc.) of the medical device or components/regions thereof and/or alternative medical devices (e.g., marketed a competitor)); ordering information (e.g., enabling the individual to place an order for the medical device), instructions for using the medical device, indications for which the medical device finds use, information relating to FDA approval and/or FDA warnings regarding the medical device (e.g., presenting to the individual the indications for which the medical device is FDA-approved, presenting one or more warnings to the individual consistent with any FDA warnings that the medical device should not be used in a certain way or on individuals having a certain medical condition, and/or the like), or any combination thereof.

### Physical Computer Readable Media

Aspects of the invention include physical computer readable media. The physical computer readable media has instructions stored thereon. The instructions include instructions for receiving unique identification code information associated with a product (e.g., a medical device), instructions for acquiring a representation of the product from a physical computer readable medium where the representation of the product is stored, instructions for displaying the representation of the product on the touch screen interface, and instructions for responding to a user interacting with the representation via the touch screen interface.

Physical computer readable media of the present disclosure include, but are not limited to, disks (e.g., magnetic or optical disks), solid-state storage drives, cards, tapes, drums, punched cards, barcodes, and magnetic ink characters and other physical medium that may be used for storing representations, instructions, and/or the like.

The instructions for receiving unique identification code information associated with a product are such that information from any identification code of interest may be received. In certain aspects, the instructions are for receiving unique identification code information (e.g., relating to the manufacturer, product code, serial number, lot number, and/or the like) from an identification code selected from a 2D matrix code, a bar code, a radio frequency identification (RFID) tag, a near-field communication (NFC) tag, a numeric code, individually-generated unique images, custom graphics, and combinations thereof. According to certain embodiments, the unique identification code information is received from a 2D matrix code (e.g., a QR Code®).

As set forth above, in certain aspects, the product is a medical device. The physical computer readable media may relate to any medical device of interest, including any of the medical devices described above with respect to the methods of the present disclosure. For example, according to certain embodiments, the product is a medical device selected from an implant, an implant delivery system, a minimally invasive interventional device, a surgical instrument, a diagnostic device, a monitoring device, a life support device, an electrophysiology device, a robotic device, a prosthetic device, an imaging device, equipment thereof, and combinations thereof. Medical devices of interest include, but are not limited to, a catheter, a stent, a defibrillator, a pacemaker, a prosthesis, orthopedic hardware, a tympanostomy tube, an intraocular lens, a dialysis machine, a laryngoscope, a bronchoscope, an electrocardiography (ECG) machine, a blood pressure monitor, and a blood glucose monitor.

The physical computer readable medium where the representation of the product is stored may be the same physical computer readable medium where the program instructions are stored. In other aspects, the physical computer readable medium where the representation of the product is stored is present in a remote server, where acquiring a representation of the product from the remote server may be facilitated by a communication network, as described in more detail above.

Physical computer readable media of the present disclosure may include program instructions for carrying out any of the steps or provide any of the functionalities or information, as described above with respect to the subject methods and systems.

### Utility

The subject methods, systems and physical computer readable media of the present disclosure find use in any application in which it is desirable to, e.g., train an individual on product usage. As described elsewhere herein, in certain aspects, the methods, systems and physical computer readable media of the present disclosure find use in training individuals on the use of medical devices. The present disclosure according to these aspects provide, inter alia: cost effective tools that allow physicians, nurses, nurse technicians and other care providers to practice the use of a medical device shortly before the device is used in actual clinical practice and on a patient; training delivered “on-site” (e.g., in hospitals and/or clinics), obviating the need for the individual to travel to a remote training location; highly specific, procedure-related training that can be delivered in a short timeframe, for example between surgeries in an operating theater (which is desirable, e.g., in emerging countries with low physician-to-patient ratios, among other places).

Existing technologies are deficient in a number of respects. For example, practicing on animals is cost-prohibitive, generally unavailable on demand and in hospitals, and is challenged by increasing regulation. Complex simulators are also cost-prohibitive, generally unavailable on demand and in hospitals, and are only available for a small set of medical devices and procedures. Typically, both animal lab training and simulator training requires a training session to be organized, scheduled, and the trainees to travel to the training site. These complications limit the availability of training for a small section of the population in need thereof.

The methods, systems and physical computer readable media of the present disclosure constitute a superior alternative to existing training modalities, because of their low cost, availability on demand, availability in hospitals, availability in large volume (e.g., scalable), and ability to deliver high quality training that improves the performance of physicians, nurses, nurse technicians, and other healthcare providers for better clinical outcomes.

### EXAMPLES

As can be appreciated from the disclosure provided above, the present disclosure has a wide variety of applications. Accordingly, the following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Those of skill in the art will readily recognize a variety of noncritical parameters that could be changed or modified to yield essentially similar results.

### Training Aid for a Catheter-Type Device that Releases an Implant

In this example embodiment of the present disclosure, a system and method relating to a catheter-type medical device is described. The device includes a catheter shaft attached to a handle. The catheter portion contains an implant in a constrained, small diameter form. The implant is released from the catheter by user action and inputs in the handle, and regains an intended three-dimensional shape once released from the catheter and unconstrained. The catheter in this example has a tapered tip section that is about 10% of the length of the entire shaft. The shaft is two to three times the length of the handle. The handle has a breakable locking mechanism at the transition between handle and catheter, a button and a sliding lever proximal to the breakable seal. A single lumen runs through the middle of the handle and catheter shaft. The device is packaged in a tray, placed inside a pouch, which is inside a box. The catheter shaft of the device is folded back in the tray, such that the distal tip is next to the proximal end of the handle. A syringe is also on the tray, packaged and sterilized with the device.

### Code

A two-dimensional code, such as a QR Code®, is attached to the outer packaging of the device, the inner packaging pouch, and the tray.

### Computing Device

In this example, the computer is a camera-equipped tablet computer, such as an iPad.

### Initiation of the Software

To initiate the software, the user launches the training application on the tablet computer. The user then directs the tablet's camera toward the two-dimensional code on the medical device box. The training application recognizes the type of medical device, initiates the appropriate training program, and displays the first training screen.

### Screens

### X-Ray View Screen

In this example, an X-ray view screen appears first. The device is lying in its tray is displayed, alongside the syringe on the tray. The catheter portion of the device is folded back such that the catheter tip is positioned next to the proximal end of the handle. The device, tray and syringe can be viewed in 3D from all sides. Touching the tray makes the tray and syringe fade away, and the device straighten out. Four tabs are displayed on this first screen: “Technical”, “Interactive”, “Ordering info” and “IFU”.

### Technical Screen

The “Technical” screen provides technical information about the device. This screen shows the straight device. A circle is drawn around the tip, and another around the shaft. Touching inside the circle drawn around the tip brings up a bar chart comparing tip softness of the device to Competitor 1 and Competitor 2. Touching inside the circle around the shaft triggers a cross section view of the shaft, the view showing three layers around a central lumen, with the following labels, from outside to inside: “hydrophilic coating”, “braided shaft”, “PTFE lining” and “guidewire lumen”.

### IFU Screen

An “IFU” screen contains an electronic version of the device IFU (“Instructions for Use”), in multiple languages, with hypertext facilitating navigation and a glossary of terms, if necessary.

### Ordering Info Screen

An “Ordering Info” screen contains a table with various configurations in which the device is available. For example, it can show three shaft lengths (40 cm, 80 cm, and 120 cm) and a part number for each. A hyperlink on this screen takes the user to the website where the device can be ordered.

### Interactive Screen

An “Interactive” screen is used to demonstrate and to practice the use of the medical device. It provides an interactive means to rehearse the steps the user must execute in order to properly release the implant the device is designed to deliver.

When the interactive screen is accessed, an image of the straight medical device is displayed. Two tabs are on this screen (labeled “Tip Performance” and “Prep & Deploy”), providing the user with a choice of available training content. Touching “Tip Performance” brings up a section of a wall in front of the catheter tip. Arrows provide a clue that the device can be pushed against the wall. A finger can now be placed on the handle and the device pushed toward the wall. As the device's tip reaches the wall the catheter shaft bends. Two more shafts appear alongside the device, one labeled Competitor 1 and the other Competitor 2. These shafts also bend as the device is moved back and forth, showing different bend characteristics, e.g. one stiffer at the tip, bending less at the tip and more along the entire shaft length, and the other softer, bending more at the tip and less along the rest of the shaft, for the same amount of handle movement.

Touching “Prep & Deploy” brings up the image of the straight medical device, the syringe and numbers indicating a sequence. The number “1” appears next to the syringe. The syringe can be moved to the proximal end of the handle, and the plunger can be pushed to flush the lumen. When touching the image of the syringe on screen, a label shows that it is filled with “Saline”. At a convenient location on the screen, the words “Flush guidewire lumen” appear. The number “2” is next to the breakable seal at the handle-catheter transition. Touching the image of the seal separates it, and it can be pulled away from the device until it dissolves at some distance away from the device. The words “Remove seal” appear. The number “3” is next to the image of the button. The button can be pushed in, and the words “Activate release mechanism” appear. The number “4” is next to the image of the sliding lever. Pulling the slider back deploys a device through the distal end of the catheter, by sliding the catheter shaft back, away from the tip, and the device deploying between the tip and the rest of the catheter shaft. An implant is deployed and as it is deployed it opens up into its intended 3D configuration on screen. The word “Deployment” appears, and next to it the word “Zoom”. Tapping Zoom provides an enlarged view of the tip and the deployed structure, which can be viewed from different angles, and from closer or further away. Touching the Prep & Deploy tab resets the sequence.

Accordingly, the preceding merely illustrates the principles of the present disclosure. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A system comprising:
a touch screen interface;
a processor;
a physical computer readable medium; and
program instructions stored on the physical computer readable medium and executable by the processor to:
receive unique identification code information associated with a product;
acquire a representation of the product from a physical computer readable medium where the representation of the product is stored;
display the representation of the product on the touch screen interface; and
respond to a user interacting with the representation via the touch screen interface.

2. The system of claim 1, wherein the product is a medical device.

3. The system of claim 2, wherein the medical device is selected from the group consisting of: an implant, an implant delivery system, a minimally invasive interventional device, a surgical instrument, a diagnostic device, a monitoring device, a life support device, an electrophysiology device, a robotic device, a prosthetic device, an imaging device, equipment thereof, and combinations thereof.

4. The system of claim 1, wherein the unique identification code information is received from a code selected from the group consisting of: a two-dimensional (2D) matrix code, a bar code, a radio frequency identification (RFID) tag, a near-field communication (NFC) tag, a numeric code, individually-generated unique images, custom graphics, and combinations thereof.

5. The system of claim 4, wherein the unique identification code information is received from a 2D matrix code.

6. The system of claim 1, wherein the unique identification code information is received from a code disposed on the product, packaging of the product, or both.

7. The system of claim 1, wherein the system is selected from a smartphone, a tablet computer, a laptop computer, and a desktop computer.

8. The system of claim 1, wherein the physical computer readable medium where the representation of the product is stored is present in a remote server.

9. The system of claim 1, wherein the representation of the product is an image of the product.

10. The system of claim 9, comprising program instructions to display information relating to a portion of the product in response to a user touching a corresponding portion of the image via the touch screen interface.

11. The system of claim 9, wherein the image is a three-dimensional image.

12. The system of claim 9, comprising program instructions to move the image in three-dimensional space.

13. The system of claim 12, wherein the image is moved in response to a user touching the image via the touch screen interface.

14. The system of claim 12, wherein the image of the product is associated with a real object in the field of view of a camera of the system.

15. The system of claim 14, wherein the image is moved by moving the object within the field of view of the camera.

16. A physical computer readable medium having instructions stored thereon, the instructions comprising:
instructions for receiving unique identification code information associated with a product;
instructions for acquiring a representation of the product from a physical computer readable medium where the representation of the product is stored;
instructions for displaying the representation of the product on the touch screen interface; and
instructions for responding to a user interacting with the representation via the touch screen interface.

17. The physical computer readable medium of claim 16, wherein the unique identification code information is received from a code selected from the group consisting of: a two-dimensional (2D) matrix code, a bar code, a radio frequency identification (RFID) tag, a near-field communication (NFC) tag, a numeric code, individually-generated unique images, custom graphics, and combinations thereof.

18. (canceled)

19. The physical computer readable medium of claim 16, wherein the product is a medical device.

20. (canceled)

21. The physical computer readable medium of claim 16, wherein the physical computer readable medium is present in a computer selected from the group consisting of: a smartphone, a tablet computer, a laptop computer, and a desktop computer.

22. A method of training an individual on product usage, comprising:
reading a unique identification code associated with a product using an identification code reader of a computer;
acquiring a representation of the product from a physical computer readable medium where the representation of the product is stored;
displaying the representation of the product on a touch screen interface of the computer; and
allowing an individual to interact with the representation of the product using the touch screen interface to train the individual on product usage.

23. The method of claim 22, wherein the product is a medical device.

24. (canceled)

25. The method of claim 22, wherein the unique identification code information is received from a code selected from the group consisting of: a two-dimensional (2D) matrix code, a bar code, a radio frequency identification (RFID) tag, a near-field communication (NFC) tag, a numeric code, individually-generated unique images, custom graphics, and combinations thereof.

26. (canceled)

27. The method of claim 22, wherein the unique identification code is disposed on the product, packaging of the product, or both.

28. The method of claim 22, wherein the identification code reader is a camera of the computer.

29. The method of claim 22, wherein the physical computer readable medium is present in the computer or on a remote server.

30. (canceled)

31. The method of claim 22, wherein displaying the representation of the product comprises displaying an image of the product.

32. The method of claim 31, wherein the image is a three-dimensional image.

33. The method of claim 31, wherein interacting with the representation of the product comprises touching the image of the product via the touch screen interface.

34. The method of claim 33, comprising touching a portion of the image to display information relating to the corresponding portion of the product.

35. The method of claim 33, comprising touching the image of the product to rotate the image in virtual three-dimensional space.

36. The method of claim 31, wherein the image of the product is associated with a real object in the field of view of a camera of the computer.

37. The method of claim 36, wherein interacting with the representation of the product comprises moving the object within the field of view of a camera.

38. The method of claim 22, wherein the computer is selected from the group consisting of: a smartphone, a tablet computer, a laptop computer, and a desktop computer.
